(19) United States
(12) Patent Application Publication
(10) Pub. No.: US 2026/0328484 A1
(43) Pub. Date: Oct. 22, 2026

(54) HEAT EXCHANGER

(71) Applicant: Conflux Technology Pty Ltd, Grovedale, Victoria (AU)

(72) Inventors: Glenn REES, Grovedale, Victoria (AU); Gabrian BALELANG, Grovedale, Victoria (AU); Michael FULLER, Grovedale, Victoria (AU)

(21) Appl. No.: 19/103,480

(22) PCT Filed: Aug. 11, 2023
(86) PCT No.: PCT/AU2023/050758

§ 371 Date: Feb. 12, 2025

(30) Foreign Application Priority Data
Aug. 12, 2022 (AU) 2022902284

(51) Int. Cl. F28D 9/00

(52) U.S. Cl. CPC F28D 9/0062

(57) ABSTRACT

A cartridge heat exchanger for transferring heat between a first working fluid and a second working fluid includes a cartridge body having first working fluid inlet and outlet ports disposed to opposite ends, and second working fluid inlet and outlet ports disposed to opposite sides. An internal wall structure of the cartridge body defines a plurality of first working fluid conduits (‘first conduits’) extending between the first working fluid inlet and outlet ports from one end of the cartridge body to the other, the first conduits being elongate in a transverse sectional dimension and the first conduits being spaced from one another such that the spaces between adjacent first conduit walls define second working fluid conduits (‘second conduits’) extending between the second working fluid inlet and outlet ports from one side of the cartridge body to the other.

### FIELD

The invention relates to heat exchangers.

In particular, the present disclosure relates to heat exchangers that are configured to be received in a housing. The term “cartridge heat exchanger” has been used throughout this specification to refer to this type of heat exchanger, having a core structure that is configured to be fitted inside and sealed within a separate housing. The housing may be a standalone structure, or it may be integral with another component such as gearbox housing.

More specifically, the present disclosure relates to micro cartridge heat exchangers, typically cartridge heat exchangers in which the fluid flows within conduits having one or more lateral dimensions generally under 1 mm.

### BACKGROUND

Micro cartridge heat exchangers are lightweight, highly compact and efficient due to heat exchange conduits having small lateral dimension(s) and resultant high surface area density for heat transfer. They are suitable for various applications, particularly in the aerospace and automotive/motorsport fields due to compactness.

Existing micro cartridge heat exchangers are typically microtube cartridge heat exchangers comprising two parallel and spaced-apart tube plates, connected by a plurality of straight microtubes. Each of the microtubes typically has a diameter under 1 mm. In use, a first fluid flows through the microtubes, and a second fluid flows outside of the microtubes. The microtubes may comprise hypodermic tubing.

Conventional methods of manufacturing microtube cartridge heat exchangers involve laboriously arranging and bonding (eg via brazing, soldering or adhering) hundreds to thousands of the microtubes to each of the tube plates. This expensive process requires the production of multiple individual parts and subsequent tedious assembly of the parts, resulting in long build times. Additionally, conventional manual assembly methods are susceptible to poor connection and sealing between the components, leading to high scrap rates and/or eventual failure of the heat exchanger. The conventional process is also highly inflexible, as any design change typically requires replacement of multiple manufacturing parts and jigging components.

Conventional microtube cartridge heat exchangers are typically limited in geometry to straight tubes. FIG. 1 is a schematic side elevation illustration of a conventional microtube cartridge heat exchanger 1000, configured to have a first fluid flowpath through the microtubes 1006 in the direction 1012 and a second fluid flowpath between the microtubes 1006 (ie into the page). In order to create a seal between the tube plates 1002, 1004 of the heat exchanger and the external housing, and maintain separation of the two fluid domains, the tube plates necessarily project outwardly of the arrangement of microtubes 1006. To maintain even flow of the fluid between the microtubes, the space on each side of the conventional heat exchanger delineated by the projecting portions of the tube plates, the straight microtubes and the wall of the housing has to be blocked off with an infill plate 1010. That is, infill plates are required to block off these spaces to reduce the amount of fluid that bypasses the working heat transfer area. It will be appreciated that the infill plates result in wasted space and less efficient heat transfer at the sides of the heat exchanger.

The restriction of conventional microtube cartridge heat exchangers to straight tubes also results in limited ability to vary the surface area ratio between the two fluid domains. This ratio is effectively fixed by the internal and external diameters of the hypodermic needles.

In this context, there is a need for improved micro cartridge heat exchangers.

### SUMMARY

According to an aspect of the present invention, there is provided a micro cartridge heat exchanger for transferring heat between a first working fluid and a second working fluid, comprising: a first plate defining an inlet for the first working fluid; a second plate defining an outlet for the first working fluid; a plurality of conduits (“first working fluid conduits”) spanning between the first and second plates, defining a first working fluid flow path through which the first working fluid is to flow in use; and a plurality of conduits (“second working fluid conduits”) spanning between the first and second plates, the second working fluid conduits defining a second working fluid flow path through which the second working fluid is to flow in use; wherein the first and second working fluid conduits are arranged in alternating layers, the arrangement extending to substantially the outermost edges of each of the first and second plates; and wherein the micro cartridge heat exchanger is configured to be received in a housing comprising a first working fluid entry duct, a first working fluid exit duct, a second working fluid entry duct and a second working fluid exit duct, the configuration being such that when the micro cartridge heat exchanger is in the housing, the first working fluid entry duct is in fluid connection with said inlet for the first working fluid, the first working fluid exit duct is in fluid connection with said outlet for the first working fluid, and the second working fluid entry and exit ducts are in fluid connection with the second working fluid conduits.

The first working fluid conduits and the second working fluid conduits may extend substantially perpendicular to the first and second plates.

Upper and lower sides of the heat exchanger may be defined by the first and second plates respectively, wherein opposing first and second lateral sides of the heat exchanger are each defined by a wall of a first working fluid conduit or a wall of a second working fluid conduit, and wherein the first working fluid conduits and/or the second working fluid conduits extend between opposing third and fourth lateral sides of the heat exchanger.

The size of the first plate may differ from that of the second plate, such that the wall of the first working fluid conduit or the wall of the second working fluid conduit defining each of the first and second lateral sides of the heat exchanger is not planar.

When the heat exchanger is received in the housing, the second working fluid entry duct may be adjacent the third lateral side of the heat exchanger and the second working fluid exit duct may be adjacent the fourth lateral side of the heat exchanger.

The first working fluid conduits may comprise a series of flat tubes, each tube extending vertically between the first and second plates and extending horizontally between the third and fourth sides of the heat exchanger.

The micro cartridge heat exchanger may further comprise turbulators arranged within each flat tube.

The second working fluid conduits may comprise a series of finned chambers, each chamber extending vertically between the first and second plates and extending horizontally between the third and fourth lateral sides of the heat exchanger.

The first and second working fluid flow paths may be perpendicular to each other, defining a crossflow configuration.

The micro cartridge heat exchanger may have a unitary and joint-less construction.

In a further aspect of the present invention, there is provided a heat transfer assembly comprising: the micro cartridge heat exchanger as described; and a housing comprising an aperture within which the micro cartridge heat exchanger is mounted, the housing further comprising a first working fluid entry duct in fluid connection with said inlet for the first working fluid, a first working fluid exit duct in fluid connection with said outlet for the first working fluid, a second working fluid entry duct in fluid connection with the second working fluid conduits and a second working fluid exit duct in fluid connection with the second working fluid conduits.

The housing may comprise: a first working fluid manifold interposed between, and in fluid connection with each of, the first working fluid entry duct and said inlet for the first working fluid; and a second working fluid manifold interposed between, and in fluid connection with each of, the second working fluid entry duct and said second working fluid conduits.

Each of the first and second lateral sides of the heat exchanger may be directly adjacent a lateral wall of the aperture of the housing.

In another aspect of the present invention, there is provided a micro cartridge heat exchanger for transferring heat between a first working fluid and a second working fluid, comprising: a first plate defining an upper side of the heat exchanger and comprising an inlet for the first working fluid; a second plate defining a lower side of the heat exchanger and comprising an outlet for the first working fluid; a plurality of flat tubes, each tube extending vertically between the first and second plates, the plurality of flat tubes defining a first working fluid flow path through which the first working fluid is to flow in use; and a plurality of finned chambers, each chamber extending vertically between the first and second plates and extending horizontally between front and rear sides of the heat exchanger, the plurality of finned chambers defining a second working fluid flow path through which the second working fluid is to flow in use; wherein the flat tubes and finned chambers are arranged in alternating layers, the arrangement extending to substantially the outermost edges of each of the first and second plates, such opposite first and second lateral sides of the heat exchanger are each defined by a wall of a flat tube or a wall of a finned chamber; wherein the micro cartridge heat exchanger is configured to be received in a housing comprising a first working fluid entry duct, a first working fluid exit duct, a second working fluid entry duct and a second working fluid exit duct, the configuration being such that when the micro cartridge heat exchanger is in the housing, the first working fluid entry duct is in fluid connection with said inlet for the first working fluid, the first working fluid exit duct is in fluid connection with said outlet for the first working fluid, and the second working fluid entry and exit ducts are in fluid connection with the finned chambers.

The micro cartridge heat exchanger may further comprise turbulators arranged within each flat tube.

The turbulators may comprise a plurality of pin-like structures, each extending across the width of the flat tube.

The finned chambers may comprise a plurality of chevron-shaped fins, each fin perforated with a plurality of apertures.

In a further aspect of the present invention, there is provided a heat transfer assembly comprising the micro cartridge heat exchanger as described; and a housing comprising an aperture within which the micro cartridge heat exchanger is mounted, the housing further comprising a first working fluid entry duct in fluid connection with said inlet for the first working fluid, a first working fluid exit duct in fluid connection with said outlet for the first working fluid, a second working fluid entry duct in fluid connection with the finned chambers and a second working fluid exit duct in fluid connection with the finned chambers.

Each of the first and second lateral sides of the heat exchanger is directly adjacent a lateral wall of the aperture of the housing.

In another aspect of the present invention, there is provided a micro cartridge heat exchanger for transferring heat between a first working fluid and a second working fluid, comprising: a first plate defining an inlet for the first working fluid; a second plate defining an outlet for the first working fluid; a plurality of conduits (“first working fluid conduits”) spanning between the first and second plates, defining a first working fluid flow path through which the first working fluid is to flow in use; and a plurality of conduits (“second working fluid conduits”) spanning between the first and second plates, the second working fluid conduits defining a second working fluid flow path through which the second working fluid is to flow in use; wherein the first and second working fluid conduits are arranged in alternating layers, wherein the plates and the working fluid conduits are integrally formed with each other; and wherein the micro cartridge heat exchanger is configured to be received in a housing comprising a first working fluid entry duct, a first working fluid exit duct, a second working fluid entry duct and a second working fluid exit duct, the configuration being such that when the micro cartridge heat exchanger is in the housing, the first working fluid entry duct is in fluid connection with said inlet for the first working fluid, the first working fluid exit duct is in fluid connection with said outlet for the first working fluid, and the second working fluid entry and exit ducts are in fluid connection with the second working fluid conduits.

The present invention also provides a cartridge heat exchanger for transferring heat between a first working fluid and a second working fluid, comprising a cartridge body having: first working fluid inlet and outlet ports disposed to opposite ends; second working fluid inlet and outlet ports disposed to opposite sides; an internal wall structure defining a plurality of first working fluid conduits (‘first conduits’) extending between the first working fluid inlet and outlet ports from one end of the cartridge body to the other, the first conduits being elongate in a transverse sectional dimension and the first conduits being spaced from one another such that the spaces between adjacent first conduit walls define second working fluid conduits (‘second conduits’) extending between the second working fluid inlet and outlet ports from one side of the cartridge body to the other; sealing surfaces disposed around the cartridge body, separating the first working fluid inlet and outlet ports from the second working fluid inlet and outlet ports; wherein the cartridge heat exchanger is configured to be received in a housing comprising a first working fluid entry duct, a first working fluid exit duct, a second working fluid entry duct and a second working fluid exit duct, the configuration being such that, when the cartridge heat exchanger is in the housing, the cartridge body is sealed to the housing at the respective sealing surfaces with the first working fluid entry and exit ducts in fluid connection with said first working fluid inlet and outlet ports, and the second working fluid entry and exit ducts in fluid connection with the second working fluid inlet and outlet ports.

The first conduits may comprise flat tubes, or the tubes may be curved in one or more dimension along their path from inlet to outlet. The first conduits may be provided with turbulators extending between the walls thereof to promote turbulent flow of the first working fluid, in use.

In embodiments, the spacing between adjacent first conduit walls (i.e. the width of the second conduits) is substantially constant. The second conduits preferably has an array of fins extending between adjacent walls thereof. The array of fins may comprise rows of perforated, chevron-shaped fins aligned in a direction of flow of the second working fluid. Adjacent rows of fins may be offset from one another to promote turbulent flow of the second working fluid, in use.

In embodiments, the sealing surfaces comprise flanges around the first working fluid inlet and outlet ports, adapted to provide a seal with the housing, in use.

The micro cartridge heat exchanger may be formed via an additive manufacturing process.

### DRAWINGS

The invention may be better understood through the following detailed description of embodiments thereof, presented by way of non-limiting example only and with reference to the accompanying drawings, in which:

FIG. 1 is a schematic side elevation view of a conventional microtube heat exchanger;

FIG. 2 is a perspective view of a micro cartridge heat exchanger according to one embodiment;

FIG. 3 is a cross-sectional side elevation view of the heat exchanger of FIG. 2;

FIG. 3A is a sectional view taken from line A-A of FIG. 3;

FIG. 3B is a sectional view taken from line B-B of FIG. 3;

FIG. 4 is a side elevation view of the heat exchanger of FIG. 2;

FIG. 4A is a sectional view taken from line C-C OF FIG. 4

FIG. 5 is an exploded view of a heat transfer assembly comprising the heat exchanger of FIG. 2 and a housing configured to receive the heat exchanger;

FIG. 5A is a cutaway view of the heat transfer assembly of FIG. 5, illustrating the heat exchanger in position within a housing;

FIG. 6 is a detailed cutaway view of the heat transfer assembly illustrating the position of the lateral walls of the heat exchanger when received within the housing;

FIG. 7 is a sectional view taken from line C-C of FIG. 3, annotating detail C;

FIG. 7A is close up view of detail C from FIG. 7;

FIG. 8 is a side elevation view of the heat exchanger of FIG. 2;

FIG. 8A is a sectional view taken from line B-B of FIG. 8;

FIG. 8B is a close up view of detail D from FIG. 8A;

FIG. 9 is a perspective view of the micro cartridge heat exchanger of FIG. 2 with the upper plate removed;

FIG. 9A is a close up view of detail E from FIG. 9;

FIG. 10 is a perspective view of a cylindrical form micro cartridge heat exchanger according to another embodiment of the invention;

FIG. 11 is a side view of the cylindrical cartridge heat exchanger of FIG. 10;

FIG. 12 is a cross-sectional view through L-L of the cylindrical cartridge heat exchanger shown in FIG. 11;

FIG. 13 Is an enlarged view of section M shown in FIG. 12;

FIG. 14 is a perspective view of another form of cylindrical micro cartridge heat exchanger according to an embodiment of the invention;

FIG. 15 is a side view of the cylindrical cartridge heat exchanger of FIG. 14;

FIG. 16A is a cross-sectional view through N-N of the cylindrical cartridge heat exchanger shown in FIG. 15;

FIG. 16B is a simplified sectional view through O-O of the cylindrical cartridge heat exchanger shown in FIG. 15;

FIG. 17 is a perspective view of a heat transfer assembly including a housing and a cylindrical form micro cartridge heat exchanger according to embodiments of the invention;

FIG. 18 is a side view of the heat transfer assembly housing;

FIG. 19 is a sectional view through F-F in FIG. 18

FIG. 20 shows a longitudinal section through the heat transfer assembly, as per G-G in FIG. 19; and

FIG. 21 is an enlarged view of section H shown in FIG. 20.

### DETAILED DESCRIPTION

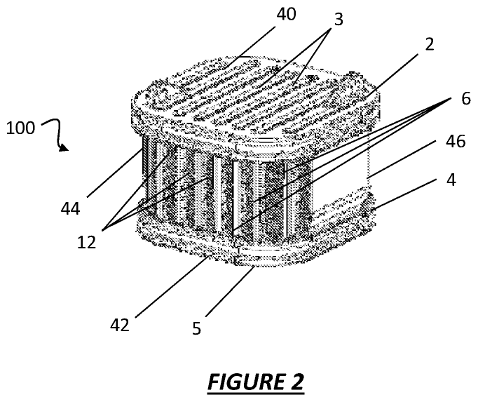

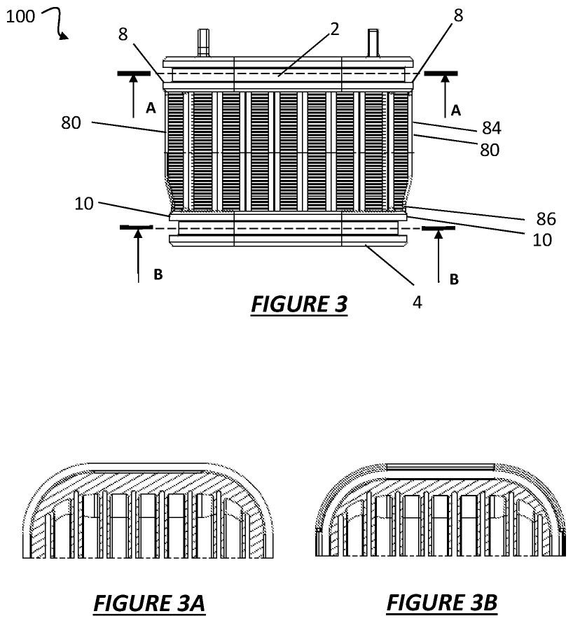

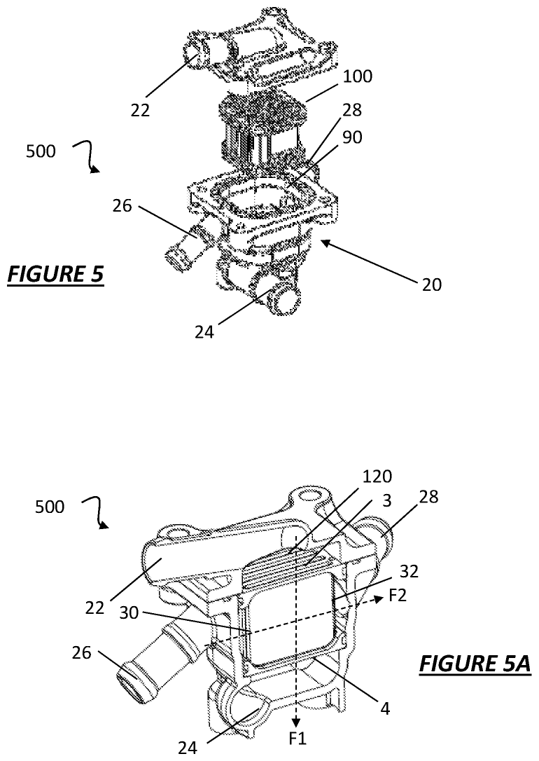

FIG. 2 illustrates a micro cartridge heat exchanger 100 according to one embodiment, comprising a first plate 2 that defines an inlet 3 for a first working fluid and a second plate 4 that defines an outlet 5 for the first working fluid. A plurality of first working fluid conduits 6 span between the first and second plates 2, 4. The first working fluid conduits 6 together define a first working fluid flow path (schematically illustrated as F1 in FIG. 5A) through which the first working fluid is to flow in use. A plurality of second working fluid conduits 12 also span between the first and second plates 2, 4. The second working fluid conduits 12 together define a second working fluid flow path (schematically illustrated as F2 in FIG. 5A) through which the second working fluid is to flow in use. The first working fluid conduits 6 and the second working fluid conduits 12 extend substantially perpendicular to the first and second plates 2, 4.

For ease of reference, the following positional references will be used throughout the specification, although it should be understood that the actual assembled/operational orientation of the heat exchanger may differ. Upper 40 and lower 42 sides of the heat exchanger are defined by the first and second plates 2, 4 respectively. Opposing first 44 and second 46 lateral sides of the heat exchanger are each defined by a wall of a first working fluid conduit 6 or a wall of a second working fluid conduit 12 (described in more detail below). The second working fluid conduits 12 extend between opposing third 48 and fourth 50 lateral sides of the heat exchanger. In preferred embodiments, the first working fluid conduits 6 also extend between the opposing third and fourth lateral sides 48, 50, to maximize the heat transfer area.

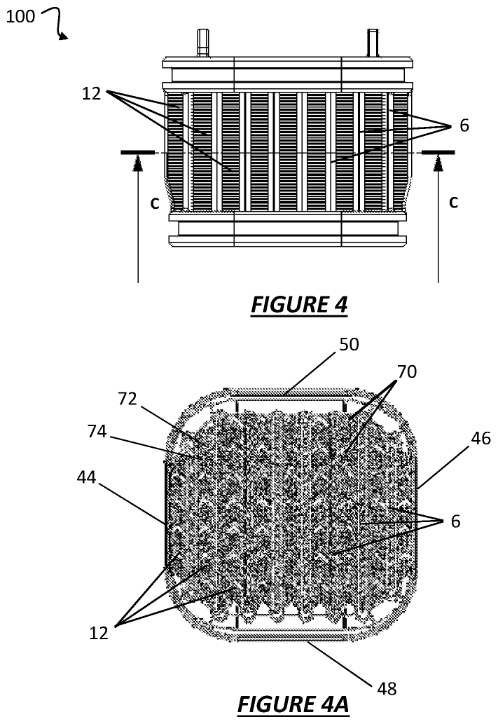

As seen more clearly in FIGS. 4 and 4A, the first and second working fluid conduits 6, 12 are arranged in alternating layers, and the arrangement extends to substantially the outermost edges 8, 10 respectively of each of the first and second plates 2, 4. Accordingly, the first 44 and second 46 lateral sides of the heat exchanger are each defined by a wall of a first working fluid conduit or a wall of a second working fluid conduit (both of these outermost walls referred to hereinafter as 80). In the illustrated embodiment, the first plate 2 is larger than the second plate 4; the walls 80 defining the outermost layers of the arrangement are therefore not planar. As shown in cross-section, each wall 80 comprises a linear portion 84 that extends downwardly from substantially the outermost edge of the first plate 2, and a curved portion 86 that is inwardly directed towards substantially the outermost edge of the second plate 4. The description “extends substantially to” as used herein is intended to cover arrangements that extend almost to the outermost edges 8, 10, but with some provision for machine tolerance, for example. In one embodiment, the arrangement of fluid conduits 6, 12 extend out to about 0.25 mm from the outermost edges 8, 10 of the first and second plates 2, 4. In other embodiments, for example where the first and second plates 2, 4 are of the same size, the walls 80 could be planar.

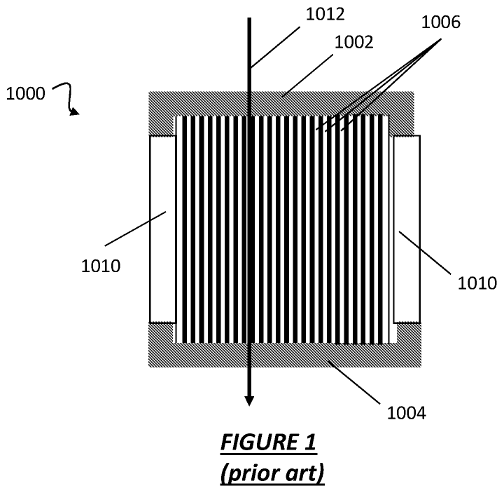

In contrast to prior art microtube heat exchangers, infill plates are not required at the sides of the heat exchanger to reduce fluid bypassing the working heat exchange surfaces. Instead, the heat exchange surfaces extend outwards on both sides of the heat exchanger, i.e. the outermost working fluid conduits extend substantially to the outermost edges 8, 10 of the first and second plates 2, 4. Accordingly, the wasted space taken up by the infill plates (such as plates 1010 illustrated in FIG. 1) at the first and second lateral sides of conventional microtube heat exchangers is, in the present invention, advantageously utilized for heat transfer. It will be appreciated that this increases the heat transfer surface area/volume (i.e. compactness) of the heat exchanger and improves performance potential.

The alternating layers of first and second working fluid conduits 6, 12 are directly adjacent to each other and extend substantially parallel with each other for efficient heat transfer.

The micro cartridge heat exchanger 100 is configured to be received in a housing 20. FIG. 5 illustrates the heat exchanger 100 received in the housing 20, together defining heat transfer assembly 500. More specifically, the heat exchanger 100 is mounted within receiving aperture 90 of the housing 20. The housing 20 comprises a first working fluid entry duct 22, a first working fluid exit duct 24, a second working fluid entry duct 26 and a second working fluid exit duct 28. As illustrated in FIG. 5A, when the micro cartridge heat exchanger 100 is in the housing 20, the first working fluid entry duct 22 is in fluid connection with the inlet 3 to direct the first working fluid into the heat exchanger 100, and the first working fluid exit duct 24 is in fluid connection with the outlet 5 to direct the first working fluid out of the heat exchanger.

The second working fluid entry and exit ducts 26, 28 are in fluid connection with the second working fluid conduits 12. In the illustrated embodiment, the second working fluid entry duct 26 is adjacent an entry side 30 (corresponding to the third lateral side 48) of the heat exchanger 100 to direct the second working fluid into heat exchanger. The second working fluid exit duct 28 is adjacent an opposite exit side 32 (corresponding to the fourth lateral side 50) of the heat exchanger to direct the second fluid out of the heat exchanger.

The housing 20 defines a first working fluid manifold 120 interposed between, and in fluid connection with each of, the first working fluid entry duct 22 and the inlet 3 for the first working fluid. The housing also defines a second working fluid manifold (not shown) interposed between, and in fluid connection with each of, the second working fluid entry duct 26 and the entry side 30 of the second working fluid conduits 12. The first and second working fluid manifolds serve to evenly distribute and deliver the first and second working fluids to the respective first and second working fluid flow paths.

The embodiment illustrated is a single pass heat exchanger, with first and second fluids each flowing through the heat exchanger in a single pass, thereby optimizing heat transfer between the two fluids. Further, as illustrated, the first and second working fluid flow paths are perpendicular to each other, defining a crossflow configuration.

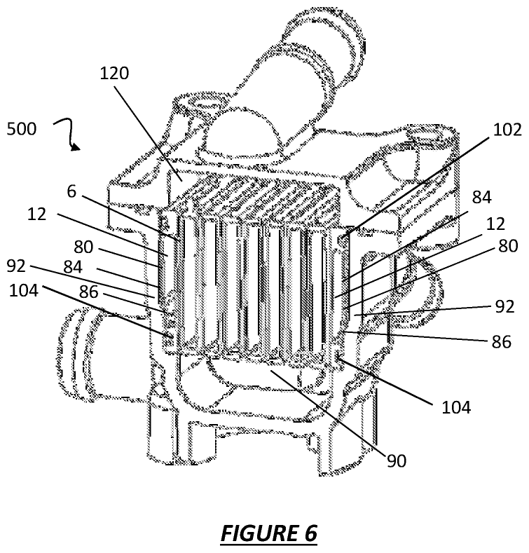

FIG. 6 illustrates in more detail the relationship between the walls 80 of the outermost fluid conduits and the walls of the receiving aperture 90 of the housing 20. Each of the first and second plates 2, 4 comprise elongated grooves 102, 104 configured to receive sealing members (not shown), which may be, for example, O-rings. The sealing members ensure sealing of the micro cartridge heat exchanger within the receiving aperture 90 of the housing. In the illustrated embodiment, the outermost fluid conduits are second working fluid conduits, and the outermost walls 80 thereof are each directly adjacent to and run substantially parallel to respective side walls 92 of the aperture 90. In one embodiment, there is a small gap of about 0.25 mm between each wall 80 and the side wall 92. This does not affect sealing of the heat exchanger 100 within the housing 20 or even flow of the second working fluid through the second working fluid conduits 12.

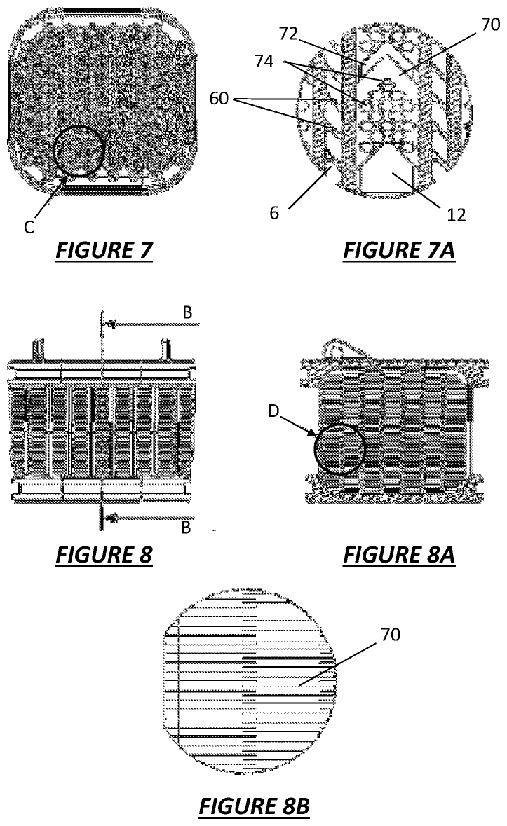

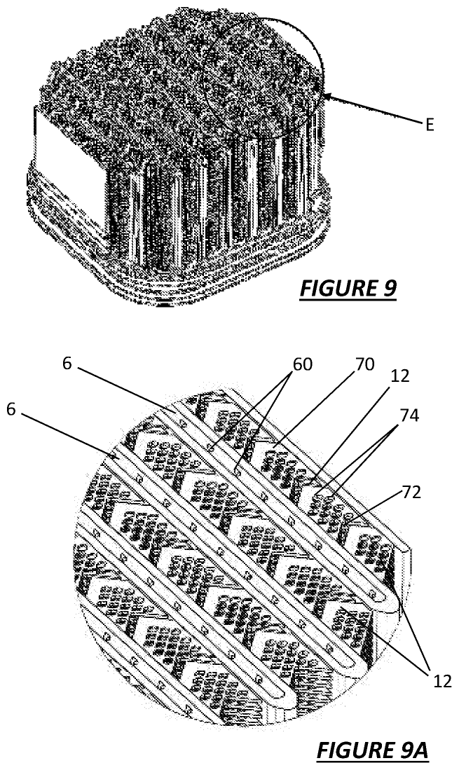

Turning now to FIGS. 7A and 9A, the first working fluid conduits 6 as illustrated comprise a series of flat plates or tubes, each extending vertically between the first and second plates 2, 4 and extending horizontally between the third and fourth sides 48, 50 of the heat exchanger. Each of the flat plates/tubes is hollow to define the first working fluid flowpath. Turbulators 60 may be arranged within each flat tube, to disrupt laminar flow and promote mixing and turbulence of the first working fluid within the tubes, thereby increasing heat transfer efficiency. In the illustrated example, the turbulators 60 are provided as pin-like structures, each spanning the width of the first working fluid conduit 6. Stacks of turbulators 60 may be arranged throughout the height and length of each flat tube and are spaced apart from each other to define the flowpath for the first working fluid. It will be appreciated that various features of the turbulators 60, such as the shape and width of each turbulator and the spacing between the turbulators may be adapted and optimized based on the specific application of the heat exchanger, e.g. based on the specific fluid properties of the first working fluid.

The second working fluid conduits 12 comprise a series of finned chambers, each chamber extending vertically between the first and second plates 2, 4 and extending horizontally between the third and fourth 48, 50 lateral sides of the heat exchanger. Fin structures 70 disposed within the second working fluid conduits 12 increase the surface area of the heat exchange surfaces. It will be appreciated that by varying the geometry of the fin structures, the surface area ratio between the two fluid domains may be optimized to suit specific fluid characteristics and/or specific boundary conditions of the heat exchanger. The fins 70 also promote mixing and turbulence of the second working fluid, thereby increasing heat transfer efficiency. Further, the fins 70 serve to reinforce and improve structural integrity of the chambers.

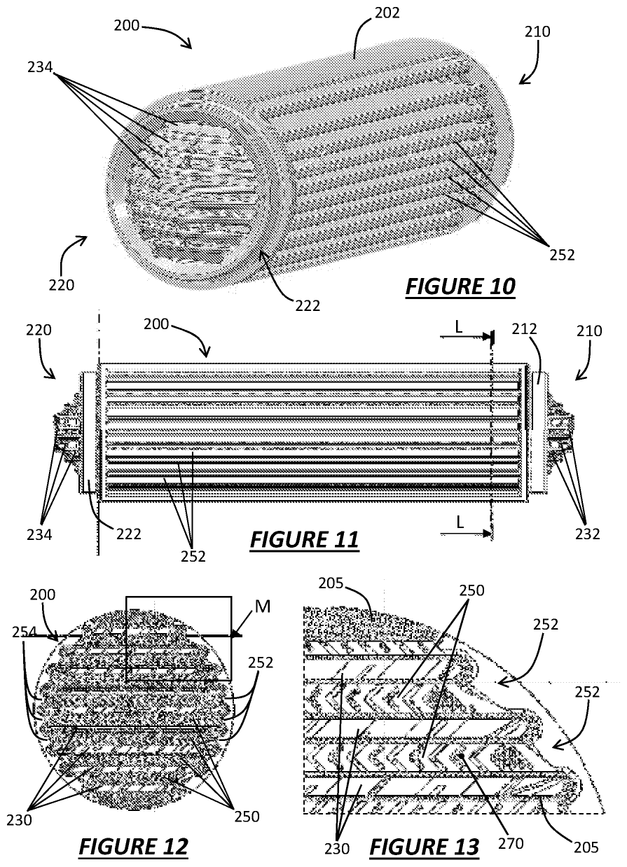

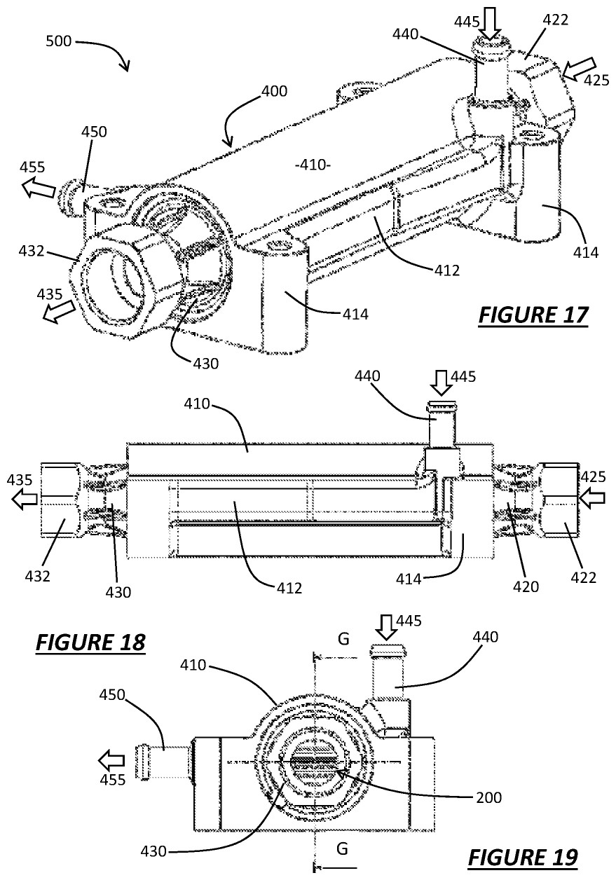

As seen more clearly in FIGS. 7A and 9A, the fin arrangement may comprise, when viewed in cross-section, chevron-shaped fins 70 perforated with apertures 74. Stacks of fins 70 may be provided along the height and width of the second working fluid conduits 12. Within each stack, the fins 70 are spaced from each other to provide the flowpath for the second working fluid. The apertures 74 provide surface disruptions on the fins 70 to enhance mixing and turbulence of the second working fluid, rather than allowing any fluid flow therethrough. Such surface disruptions may therefore additionally or alternatively be provided by protuberances, slits, etc on the fins. In the illustrated embodiment, the chevron shape of the fins 70 and the rhombus shape of the apertures 74 are particularly optimized for additive manufacturing of the heat exchanger. Further surface disruption is provided by chevron-shaped apertures 72 due to spacing of the stacks of fins from each other. It should be appreciated that the geometry and arrangement of the fins may be tuned to the specific application of the heat exchanger 100, e.g. the specific fluid characteristics of the second working fluid.

Where the cartridge heat exchanger 100 has a generally rectangular form, FIGS. 10 and 11 show a cartridge heat exchanger 200 with an alternative, generally cylindrical form. The cylindrical cartridge heat exchanger 200 is constructed to be received in a cylindrical cartridge housing 400 seen in FIGS. 17-21. Although the cartridge heat exchangers 100, 200 are quite different in appearance, in many respects they are similar in construction and operation. Like the rectangular cartridge heat exchanger 100, the cylindrical cartridge heat exchanger 200, in use, operates in a single-pass, crossflow configuration.

The cylindrical cartridge heat exchanger 200 has a generally cylindrical cartridge body 202 extending between first and second ends 210, 220. Each of the first and second ends has a respective cylindrical flange 212, 222 with a sealing surface. The heat exchanger body has an internal structure of walls 205 that form first working fluid conduits (‘first conduits’) 230 extending from inlet ports 232 at the first end to outlet ports 234 at the second end. As seen best in the cross-sectional view in FIG. 12, each of the first conduits 230 has the form of a narrow slot, the breadth of which extends from one side of the cartridge body to the other. The first conduits 230 are arranged in layers with narrow gaps therebetween which comprise second working fluid conduits (‘second conduits’) 250. The second conduits 250 extend from inlets ports 252 on one side of the heat exchanger to outlet ports 254 on the other side. In the embodiment shown in FIGS. 10-13, the cartridge heat exchanger 200 has nine of the first conduits 230 and ten of the second conduits 250 (the two peripheral second conduits 250 are between the outer wall of the heat exchanger body and the outermost first conduits 230).

As in heat exchanger 100, turbulators may be arranged within each of the first conduit tubes, to provide structure and to disrupt laminar flow and promote mixing and turbulence of the first working fluid, in use, thereby increasing heat transfer efficiency. For instance, the turbulators may be provided as pin-like structures, each spanning the narrow width of the first working fluid conduit 230. Stacks of turbulators may be arranged throughout the breadth and length of each of the first conduits 230, spaced apart from one another to define the flowpath for the first working fluid. It will be appreciated that various features of the turbulators, such as the shape and width of each turbulator and the spacing between the turbulators may be adapted and optimized based on the specific application of the heat exchanger, e.g. based on the specific fluid properties of the first working fluid.

The second working fluid conduits 250 comprise a series of finned chambers, each chamber extending from one side of the heat exchanger to the other. Fin structures 270 (FIG. 13) disposed within the second working fluid conduits 250 increase the surface area of the heat exchange surfaces. It will be appreciated that by varying the geometry of the fin structures, the surface area ratio between the two fluid domains may be optimized to suit specific fluid characteristics and/or specific boundary conditions of the heat exchanger. The fins 270 also promote mixing and turbulence of the second working fluid, thereby increasing heat transfer efficiency. Further, the fins 270 serve to reinforce and improve structural integrity of the chambers. The structure and arrangement of the fins 270 may be the same as the fins 70 described above in connection with the first embodiment.

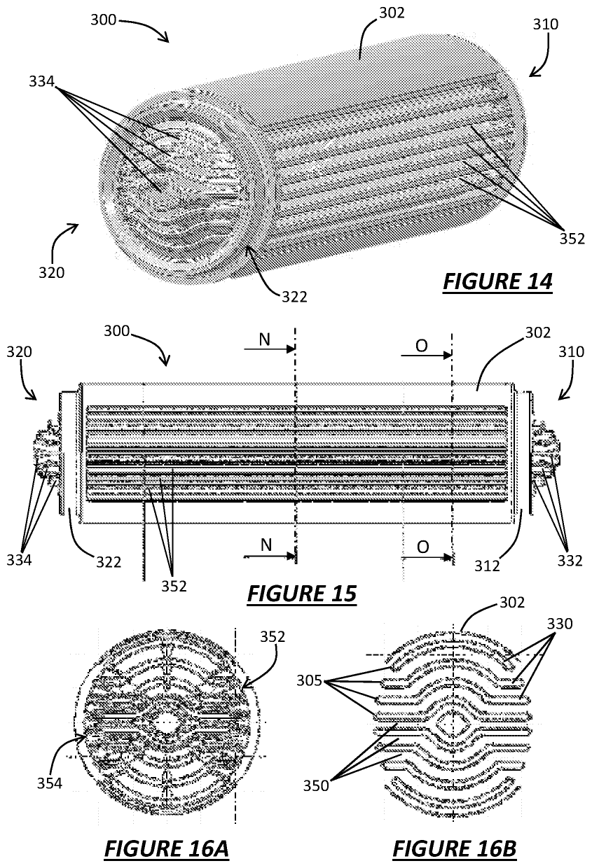

Another cylindrical form micro cartridge heat exchanger 300 is shown in FIGS. 14-16. The cylindrical cartridge heat exchanger 300 is constructed to be received in the same kind of cylindrical cartridge housing 400 as the heat exchanger 200 (described below).

The cylindrical cartridge heat exchanger 300 has a generally cylindrical cartridge body 302 extending between first and second ends 310, 320. Each of the first and second ends has a respective cylindrical flange 312, 322 of reduced diameter. The heat exchanger body has an internal structure of walls 305 that form first working fluid conduits (‘first conduits’) 330 extending from inlet ports 332 at the first end to outlet ports 334 at the second end. As seen best in the cross-sectional view in FIGS. 16A and 16B, each of the first conduits 330 has the form of a narrow slot, the breadth of which extends from one side of the cartridge body to the other.

The primary difference between heat exchanger 300 as compared with heat exchanger 200 is in the configuration of the first and second conduits, which results in a modified flow path for the second working fluid in particular. Where the heat exchanger 200 has conduits that extend linearly from one side of the heat exchanger body to the other, heat exchanger 300 has conduits that follow the contour of the cylindrical shell. This is best seen in FIG. 16B which shows a simple section through the heat exchanger 300 at O-O of FIG. 15. As shown, the outermost slots of the first conduits 330 bow outwardly with constant spacing from the outer shell and the successive layers of inner conduits 330 follow suit. As shown in FIG. 16A, the walls defining the conduits curve in all three dimensions from one end to the other of the heat exchanger 300.

As previously described, the first conduits 330 are arranged in layers with narrow gaps therebetween, and the gaps comprise the second working fluid conduits (‘second conduits’) 350. The second conduits 350 extend from inlets ports 352 on one side of the heat exchanger to outlet ports 354 on the other side, in this case following a somewhat convolute path. In the embodiment shown in FIGS. 14-16, the cartridge heat exchanger 300 has nine of the first conduits 330 (including a central tube), and ten of the second conduits 350 (the two peripheral second conduits 350 are between the outer wall 302 of the heat exchanger body and the outermost first conduits 330).

The cylindrical cartridge heat exchangers 200, 300 are each designed to be received in a housing 400 to form a heat transfer assembly 500 (FIG. 17). The housing 400 has a housing body 410 with a mounting boss 414 at each corner for mounting the assembly 500 in use. The housing body defines a cylindrical internal chamber for receiving a cartridge heat exchanger 200, 300. The housing body 410 also defines a longitudinal channel 412 on each side of the cylindrical chamber. Removable end caps 420, 430 are fitted to the ends of the housing body 410, sealing against the housing body and the cartridge heat exchanger. The end caps 420, 430 provide respective entry and exits ducts 422, 432 for the first working fluid. The first working fluid entry flow direction is indicated by arrow 425, and the exit flow by arrow 435. Thus, the bulk flow of the first working fluid through the housing and through the cartridge heat exchanger 200, 300 is in an axial direction.

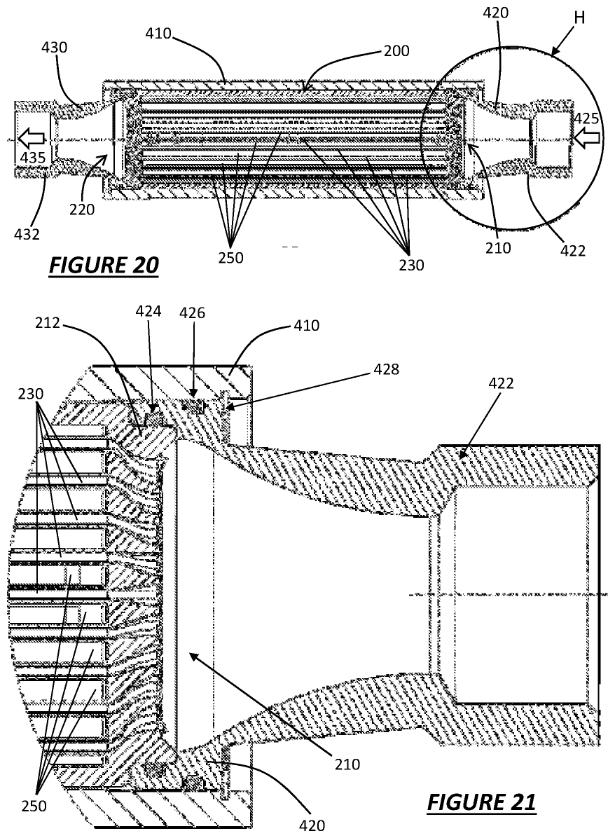

As shown in FIGS. 20 and 21, the end cap 420 closely fits within the cylindrical internal chamber of the housing body 410 and is held in place by a snap ring 428. When in place the end cap 420 is sealed against the end flange 212 of the cartridge heat exchanger 200 by way of a first O-ring 424, and is sealed against the internal surface of the housing body 410 by way of a second O-ring 426. The end cap 430 is similarly secured and sealed at the other end of the housing and heat exchanger cartridge. These seals both prevent the first and second working fluids from escaping the system, and also prevent the first and second working fluids from intermixing. When the end cap is fitted, there is a plenum space between the inside of the end cap and the end of the cartridge heat exchanger, which functions as a manifold for distribution of the first working fluid to the inlet ports 232 and thus the first conduits 230.

A second working fluid entry duct 440 is provided at one end of the housing body, and a corresponding second working fluid exit duct 450 at the other end. The entry duct 440 is coupled to the longitudinal channel 412 on one side of the cylindrical internal channel, and the exit duct 450 is coupled to the longitudinal channel on the other side. The second working fluid entry flow direction is indicated by arrow 445, and the exit flow by arrow 455. The longitudinal channels 412 allow the second working fluid to flow axially along the sides of the heat exchanger from the inlet end to the outlet end, such that the bulk flow of the second working fluid through the cartridge heat exchanger 200, 300 is from one side to the other, transverse to the axis.

The micro cartridge heat exchangers disclosed herein are preferably of a monolithic, unitary and joint-less construction. That is, the entire micro heat exchanger is created as a single part, and does not require any subsequent assembly of conduits to plates. This reduces manufacturing costs and eliminates the risk of leakage that affects prior art micro heat exchangers due to failure at assembled (e.g. brazed) joints.

Production of the micro cartridge heat exchanger via additive manufacturing also provides greater control over the parameters of the heat exchange conduits and surfaces. More complex geometry may be provided, and the geometry may be more freely adapted and optimized based on the application of the heat exchanger. For example, the geometry may be adapted to suit specific fluid properties, specific geometric constraints and conditions and/or specific boundary conditions of the heat exchanger, thereby improving performance compared with conventional heat exchangers of comparable volume. Further, changes in the geometry would not require replacement of multiple manufacturing and assembly components.

While various embodiments of the present invention have been described above, it should be understood that they have been presented by way of example only, and not by way of limitation. It will be apparent to a person skilled in the relevant art that various changes in form and detail can be made therein without departing from the spirit and scope of the invention. Thus, the present invention should not be limited by any of the above described exemplary embodiments.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavor to which this specification relates.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

1. A micro cartridge heat exchanger for transferring heat between a first working fluid and a second working fluid, comprising:
a first plate defining an inlet for the first working fluid;
a second plate defining an outlet for the first working fluid;
a plurality of conduits (“first working fluid conduits”) spanning between the first and second plates, defining a first working fluid flow path through which the first working fluid is to flow in use; and
a plurality of conduits (“second working fluid conduits”) spanning between the first and second plates, the second working fluid conduits defining a second working fluid flow path through which the second working fluid is to flow in use,
wherein the first and second working fluid conduits are arranged in alternating layers, the arrangement extending to substantially outermost edges of each of the first and second plates, and
wherein the micro cartridge heat exchanger is configured to be received in a housing comprising a first working fluid entry duct, a first working fluid exit duct, a second working fluid entry duct and a second working fluid exit duct, the configuration being such that when the micro cartridge heat exchanger is in the housing, the first working fluid entry duct is in fluid connection with said inlet for the first working fluid, the first working fluid exit duct is in fluid connection with said outlet for the first working fluid, and the second working fluid entry and exit ducts are in fluid connection with the second working fluid conduits.

2. The micro cartridge heat exchanger as claimed in claim 1, wherein the first working fluid conduits and the second working fluid conduits extend substantially perpendicular to the first and second plates.

3. The micro cartridge heat exchanger as claimed in claim 1, wherein upper and lower sides of the heat exchanger are defined by the first and second plates respectively, wherein opposing first and second lateral sides of the heat exchanger are each defined by a wall of a first working fluid conduit or a wall of a second working fluid conduit, and wherein the first working fluid conduits and/or the second working fluid conduits extend between opposing third and fourth lateral sides of the heat exchanger.

4. The micro cartridge heat exchanger as claimed in claim 3, wherein a size of the first plate differs from that of the second plate, such that the wall of the first working fluid conduit or the wall of the second working fluid conduit defining each of the first and second lateral sides of the heat exchanger is not planar.

5. (canceled)

6. The micro cartridge heat exchanger as claimed in claim 3, wherein the first working fluid conduits comprise a series of flat tubes, each tube extending vertically between the first and second plates and extending horizontally between the third and fourth lateral sides of the heat exchanger.

7. The micro cartridge heat exchanger as claimed in claim 6, further comprising turbulators arranged within each flat tube.

8. The micro cartridge heat exchanger as claimed in claim 3, wherein the second working fluid conduits comprise a series of finned chambers, each chamber extending vertically between the first and second plates and extending horizontally between the third and fourth lateral sides of the heat exchanger.

9-10. (canceled)

11. A heat transfer assembly comprising:
the micro cartridge heat exchanger as claimed in claim 1; and
a housing comprising an aperture within which the micro cartridge heat exchanger is mounted, the housing further comprising:
a first working fluid entry duct in fluid connection with said inlet for the first working fluid;
a first working fluid exit duct in fluid connection with said outlet for the first working fluid;
a second working fluid entry duct in fluid connection with the second working fluid conduits; and
a second working fluid exit duct in fluid connection with the second working fluid conduits.

12. The heat transfer assembly of claim 11, wherein the housing comprises:
a first working fluid manifold interposed between, and in fluid connection with each of, the first working fluid entry duct and said inlet for the first working fluid; and
a second working fluid manifold interposed between, and in fluid connection with each of, the second working fluid entry duct and said second working fluid conduits.

13-19. (canceled)

20. A micro cartridge heat exchanger for transferring heat between a first working fluid and a second working fluid, comprising:
a first plate defining an inlet for the first working fluid;
a second plate defining an outlet for the first working fluid;
a plurality of conduits (“first working fluid conduits”) spanning between the first and second plates, defining a first working fluid flow path through which the first working fluid is to flow in use; and
a plurality of conduits (“second working fluid conduits”) spanning between the first and second plates, the second working fluid conduits defining a second working fluid flow path through which the second working fluid is to flow in use,
wherein the first and second working fluid conduits are arranged in alternating layers,
wherein the first and second plates and the first and second working fluid conduits are integrally formed with each other, and
wherein the micro cartridge heat exchanger is configured to be received in a housing comprising a first working fluid entry duct, a first working fluid exit duct, a second working fluid entry duct and a second working fluid exit duct, the configuration being such that when the micro cartridge heat exchanger is in the housing, the first working fluid entry duct is in fluid connection with said inlet for the first working fluid, the first working fluid exit duct is in fluid connection with said outlet for the first working fluid, and the second working fluid entry and exit ducts are in fluid connection with the second working fluid conduits.

21. The micro cartridge heat exchanger as claimed in claim 1 formed via an additive manufacturing process and having a unitary and joint-less construction.

22. A cartridge heat exchanger for transferring heat between a first working fluid and a second working fluid, comprising a cartridge body having:
first working fluid inlet and outlet ports disposed to opposite ends;
second working fluid inlet and outlet ports disposed to opposite sides;
an internal wall structure defining a plurality of first working fluid conduits (‘first conduits’) extending between the first working fluid inlet and outlet ports from one end of the cartridge body to the other, the first conduits being elongate in a transverse sectional dimension and the first conduits being spaced from one another such that the spaces between adjacent first conduit walls define second working fluid conduits (‘second conduits’) extending between the second working fluid inlet and outlet ports from one side of the cartridge body to the other; and
sealing surfaces disposed around the cartridge body, separating the first working fluid inlet and outlet ports from the second working fluid inlet and outlet ports,
wherein the cartridge heat exchanger is configured to be received in a housing comprising a first working fluid entry duct, a first working fluid exit duct, a second working fluid entry duct and a second working fluid exit duct, the configuration being such that, when the cartridge heat exchanger is in the housing, the cartridge body is sealed to the housing at the respective sealing surfaces with the first working fluid entry and exit ducts in fluid connection with said first working fluid inlet and outlet ports, and the second working fluid entry and exit ducts in fluid connection with the second working fluid inlet and outlet ports.

23. A cartridge heat exchanger according to claim 22, wherein the first conduits comprise flat tubes.

24. A cartridge heat exchanger according to claim 22, wherein the first conduits comprise curved tubes.

25. (canceled)

26. A cartridge heat exchanger according to claim 22, wherein each of the first conduits are provided with turbulators extending between walls thereof to promote turbulent flow of the first working fluid, in use.

27. A cartridge heat exchanger according to claim 22, wherein each of the second conduits comprises a finned chamber in which an array of fins extend between adjacent walls of the finned chamber.

28. A cartridge heat exchanger according to claim 27, wherein the array of fins comprises rows of perforated, chevron-shaped fins aligned in a direction of flow of the second working fluid.

29. A cartridge heat exchanger according to claim 28, wherein adjacent rows of fins are offset from one another to promote turbulent flow of the second working fluid, in use.

30. A cartridge heat exchanger according to claim 22, wherein the sealing surfaces comprise flanges around the first working fluid inlet and outlet ports, adapted to provide a seal with the housing, in use.

31. A cartridge heat exchanger according to claim 22, formed by way of an additive manufacturing process.
